(19) United States
(12) Patent Application Publication
(10) Pub. No.: US 2025/0313740 A1
(43) Pub. Date: Oct. 9, 2025

(54) MOLDING COMPOSITION FOR STATOR AND COOLING SYSTEM USING SAME

(71) Applicants: HYUNDAI MOTOR COMPANY, SEOUL (KR); KIA CORPORATION, SEOUL (KR); KCC CORPORATION, SEOUL (KR)

(72) Inventors: Sung Min Kim, Seoul (KR); Dong Kyu Won, Daejeon (KR); Pung Koc Hwang, Iksan-si (KR); Ji Seung Park, Wanju-gun (KR); Byung Seon Kong, Yongin-si (KR)

(73) Assignees: HYUNDAI MOTOR COMPANY, SEOUL (KR); KIA CORPORATION, SEOUL (KR); KCC CORPORATION, SEOUL (KR)

(21) Appl. No.: 18/823,986

(22) Filed: Sep. 4, 2024

(30) Foreign Application Priority Data
Apr. 9, 2024 (KR) 10-2024-0047716

(51) Int. Cl. C09K 5/14; C08G 59/18; C08G 59/62; C08K 3/22; C08K 9/06; C08K 13/06; C09D 5/18; C09D 7/40; C09D 7/62; C09D 163/00; H02K 3/24; H02K 3/30

(52) U.S. Cl. CPC C09K 5/14; C08G 59/182; C08G 59/621; C08K 13/06; C09D 5/18; C09D 7/62; C09D 7/69; C09D 163/00; H02K 3/24; H02K 3/30; C08K 2003/2227; C08K 9/06; C08K 2201/001; C08K 2201/005

(57) ABSTRACT

A molding composition for a stator having high thermal conductivity is capable of replacing an insulator to improve thermal efficiency of a motor includes a first filler, a second filler having electrical conductivity, a third filler having electrical conductivity, a thermosetting resin, a curing agent, and an additive. A cooling system for improving heat dissipation performance by filling slots provided in a stator of a rotating electric device includes a stator body having a plurality of teeth and a plurality of slots, a stator coil inserted into each of the plurality of slots, and a molding material composition for a stator loaded inside of each of the plurality of slots and configured to cover the stator coil.

### CROSS REFERENCE TO RELATED APPLICATIONS

This application claims, under 35 U.S.C. § 119(a), the benefit of priority from Korean Patent Application No. 10-2024-0047716, filed on Apr. 9, 2024, the entire contents of which are incorporated herein by reference.

### BACKGROUND

### (a) Technical Field

The present disclosure relates to a molding composition for a stator having high thermal conductivity capable of replacing an insulator to improve thermal efficiency of a motor, and a cooling system for improving heat dissipation performance by filling slots provided in a stator of a rotating electric device therewith.

### (b) Background Art

The stator of a rotating electric device such as a motor or a power generator is configured to include an annular stator core having a plurality of slots in a circumferential direction of the inner peripheral surface thereof, and a coil wound in the slots, and an insulating sheet is inserted between the stator core and the coil to obtain electrical insulation properties.

Conventional examples of the insulating sheet include paper (trade name: Nomex® composed of fibrids and fibers of poly(meta-phenylene isophthalamide) (hereinafter referred to as “meta-aramid”), resin films of polyethylene terephthalate, etc., aramid-resin film laminates formed by laminating the meta-aramid paper and the resin film, and the like.

The thickness of existing insulators varies depending on the model, such as 300 μm, 250 μm, 220 μm, 180 μm, etc. With the recent trend of development of high-performance electric vehicles, the coil fill factor in the slots is improving, namely the insulation thickness is decreasing. However, there is a need to develop materials with high thermal conductivity while obtaining further improved material flowability (bulk molding) and gap filling characteristics.

### SUMMARY

An object of the present disclosure is to provide a molding material composition for a stator including one or more fillers having different average particle diameters (D50), a thermosetting resin, and an additive.

Another object of the present disclosure is to provide a cooling system including a stator body including pluralities of teeth and slots, a stator coil inserted into the slots, and a molding material composition for a stator loaded inside the slots and configured to cover the stator coil.

The objects of the present disclosure are not limited to the foregoing. The objects of the present disclosure will be able to be clearly understood through the following description and to be realized by the means described in the claims and combinations thereof.

An embodiment of the present disclosure provides a molding material composition for a stator, including a first filler having an average particle diameter (D50) of 10 μm to 25 μm, a second filler having an average particle diameter (D50) of 15 μm to 35 μm and having electrical conductivity, a third filler having an average particle diameter (D50) of 0.3 μm to 5.0 μm and having electrical conductivity, a thermosetting resin, a curing agent, and an additive.

The first filler may include silica (silicon dioxide, SiO₂).

The second filler may include at least one selected from among alumina (aluminum oxide, Al₂O₃), boron nitride (BN), aluminum nitride (AlN), silicon nitride (Si₃N₄), magnesia (magnesium oxide, MgO), zinc oxide (ZnO), silicon carbide (SiC), and aluminum hydroxide (Al(OH)₃).

The third filler may include at least one selected from among alumina (aluminum oxide, Al₂O₃), boron nitride (BN), aluminum nitride (AlN), silicon nitride (Si₃N₄), magnesia (magnesium oxide, MgO), zinc oxide (ZnO), silicon carbide (SiC), and aluminum hydroxide (Al(OH)₃).

The thermosetting resin may include at least one selected from among an epoxy resin, a phenol resin, and a polyurethane resin.

The curing agent may include at least one selected from among a phenol novolac resin, a cresol novolac resin, a phenol aralkyl resin, and a polyfunctional phenol compound.

The molding material composition may include 1 wt % to 35 wt % of the first filler based on the total weight of the composition.

The molding material composition may include 15 wt % to 50 wt % of the second filler based on the total weight of the composition.

The molding material composition may include 15 wt % to 50 wt % of the third filler based on the total weight of the composition.

The molding material composition may include 1 wt % to 15 wt % of the thermosetting resin based on the total weight of the composition.

The molding material composition may include 1 wt % to 8 wt % of the curing agent based on the total weight of the composition.

The molding material composition may include 2 wt % to 25 wt % of the additive based on the total weight of the composition.

The molding material composition may have thermal conductivity of 0.85 W/mK to 5.00 W/mK as measured according to ASTM E1461.

The molding material composition is capable of gap filling for a gap having a width of 100 mm, a length of 10 mm, and a thickness of 150 μm to 300 μm under molding conditions according to ASTM D 3123-72.

Another embodiment of the present disclosure provides a cooling system, including a stator body including pluralities of teeth and slots, a stator coil inserted into the slots, and a molding material composition for a stator loaded inside the slots and configured to cover the stator coil.

Each of the slots may include at least one cooling passage therein.

The cooling passage may have a hollow tube shape to allow a cooling medium to flow.

The cooling passage may be provided in each slot so as to cross the first side wall and the second side wall of the slot.

The cooling passage may be disposed between the rear wall of each slot and the stator coil.

The cooling passage may be disposed adjacent to the front wall opposite the rear wall of each slot.

At least one cooling passage may be provided to cross the first side wall and the second side wall of each slot, and a second cooling passage may be disposed adjacent to the front wall opposite the rear wall of the slot.

### BRIEF DESCRIPTION OF THE FIGURES

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 is a transverse plane in a direction of a rotation shaft of a motor according to an embodiment of the present disclosure;

FIG. 2 shows a stator body and a stator coil inserted into slots and protruding therefrom according to an embodiment of the present disclosure;

FIG. 3 is a transverse plane of the stator body and the slots according to an embodiment of the present disclosure;

FIG. 4 is a transverse plane of a stator body and slots according to another embodiment of the present disclosure;

FIG. 5 is a transverse plane of a stator body and slots according to still another embodiment of the present disclosure;

FIG. 6 is a transverse plane showing the arrangement relationship between the cooling passage and the stator coil in the slot according to an embodiment of the present disclosure; and

FIG. 7 is a transverse plane showing the arrangement relationship between the cooling passage and the stator coil in the slot according to another embodiment of the present disclosure.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

### Cooling System

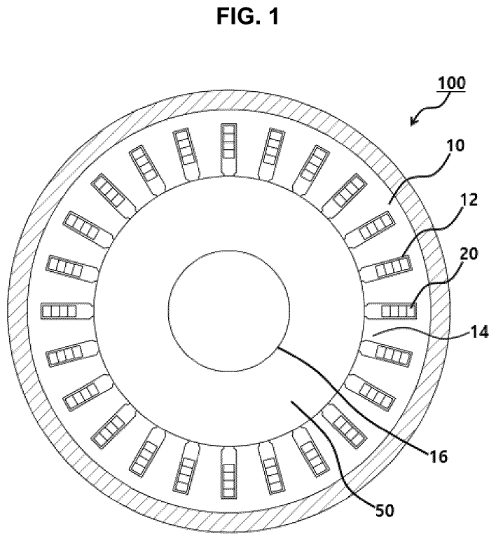

FIG. 1 is a transverse plane in a direction of a rotation shaft of a motor according to an embodiment of the present disclosure.

Referring thereto, the motor 100 may include a stator body 10 including pluralities of teeth 14 and slots 12, and a stator coil 20 inserted into the slots. The motor 100 may include a rotation shaft 16 configured to drive a rotor 50 to rotate at the center, and may additionally include a case configured to accommodate the stator body 10 on the outer peripheral surface, but the present disclosure is not limited thereto.

A cooling system according to an embodiment of the present disclosure may include a stator body including pluralities of teeth and slots and a stator coil inserted into the slots.

The stator body 10 may include pluralities of teeth 14 and slots 12. A plurality of slots 12 may each have a shape with an accommodation space therein. A plurality of teeth 14 is formed along the inner peripheral surface of the stator body 10 adjacent to the rotor 50, and each tooth may have a sawtooth shape. The teeth 14 and the slots 12 may be arranged alternately with each other in the circumferential direction of the stator body 10. More specifically, the first tooth may be disposed between the first slot and the second slot, and the second tooth may be disposed between the second slot and the third slot.

The stator coil 20 may be provided in the internal accommodation space of each of the slots 12. The stator coil 20 may be wound in the accommodation space of each slot 12. Examples of the winding process may include, but are not limited to, concentrated winding, distributed winding, etc.

The rotor 50 may contain a plurality of permanent magnets therein, and the permanent magnets may be spaced apart from each other at the same interval on the same circumference, and the arrangement angle, magnetic strength, etc. of the permanent magnets are not particularly limited. The stator body 10 may be disposed to surround the outer peripheral surface of the rotor 50. The stator body 10 may be in contact with the rotor 50 or may be slightly spaced apart therefrom, but the present disclosure is not limited thereto. The rotor 50 may be coupled with the rotation shaft 16 and may be rotated by the rotation shaft 16.

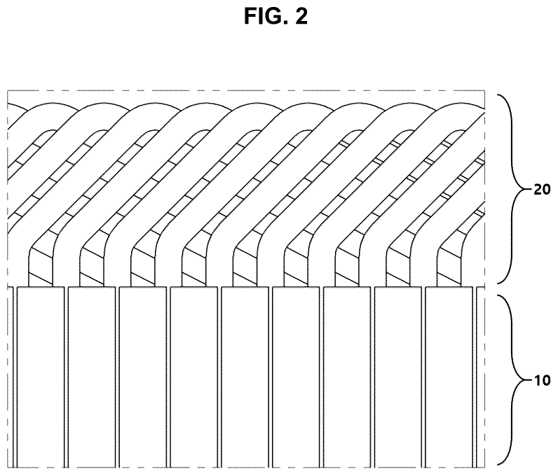

FIG. 2 shows the stator body 10 and the stator coil 20 inserted into the slots and protruding from the stator body according to an embodiment of the present disclosure. Referring thereto, in the cooling system according to an embodiment of the present disclosure, the stator coil 20 protruding from the stator body 10 is not covered with an additional housing, facilitating direct cooling in which a cooling medium is sprayed directly onto the stator coil 20.

Methods for thermal management of the motor may include, for example, direct cooling and indirect cooling. Direct cooling is a method of removing heat by bringing the cooling medium into direct contact with the motor. Indirect cooling is a method of removing heat through the external case of the motor or a heat sink, rather than direct contact of the cooling medium with the motor. The cooling medium may include a coolant, oil, refrigerant, and combinations thereof, but the present disclosure is not limited thereto. The cooling medium may be appropriately selected in consideration of the end use, size, output, and operating environment of the motor. The motor may include an oil pump and an oil sump configured to circulate the cooling medium for direct or indirect cooling, an oil cooler serving as a heat exchanger, and a pipe configured to communicate therebetween to allow the cooling medium to flow, but the present disclosure is not limited thereto.

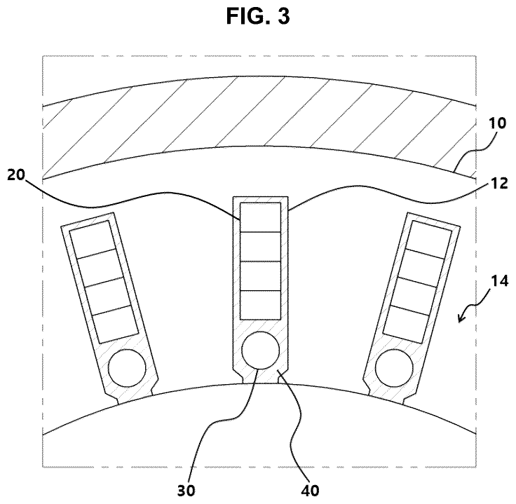

FIG. 3 is a transverse plane of a stator body and slots according to an embodiment of the present disclosure.

Referring thereto, each slot 12 according to an embodiment of the present disclosure may include a stator coil 20, a cooling passage 30, and a molding material composition 40 for a stator loaded inside the slot and configured to cover the stator coil 20 and the cooling passage 30.

The internal structure of the slot 12 according to an embodiment of the present disclosure is as follows.

The stator coil 20 is inserted into the internal accommodation space of the slot 12 so as to be adjacent to the outer peripheral surface of the stator body 10 and a member having a predetermined shape is inserted to be adjacent to the inner peripheral surface of the stator body 10, after which the molding material composition for a stator is loaded in the internal accommodation space of the slot 12 and cured. Accordingly, the cooling passage 30 may be formed adjacent to the inner peripheral surface of the stator body 10 to extend toward the rotation shaft 16. The member may have a cylindrical shape, but the present disclosure is not limited thereto.

The slot 12 may include at least one cooling passage 30 therein. The cross-sectional shape of the cooling passage 30 may be circular, but is not particularly limited thereto, and any shape may be used so long as it has a hollow tube shape so that the cooling medium flows efficiently. The motor 100 may include an oil pump and an oil sump configured to supply the cooling medium to the cooling passage 30 or discharge and circulate the same, an oil cooler, and a pipe configured to communicate therebetween to allow the cooling medium to flow.

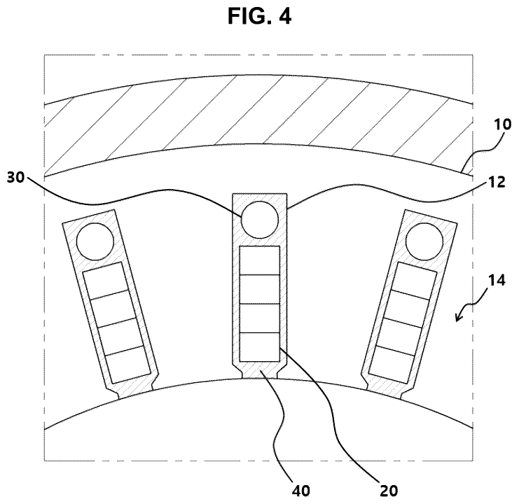

FIG. 4 is a transverse plane of a stator body and slots according to another embodiment of the present disclosure.

The internal structure of each slot 12 according to an embodiment of the present disclosure is as follows.

A member having a predetermined shape is inserted into the internal accommodation space of the slot 12 so as to be adjacent to the outer peripheral surface of the stator body 10 and a stator coil 20 is inserted to be adjacent to the inner peripheral surface of the stator body 10, after which the molding material composition for a stator is loaded in the internal accommodation space of the slot 12 and cured. Accordingly, a cooling passage 30 may be formed adjacent to the outer peripheral surface of the stator body 10 to extend toward the rotation shaft 16.

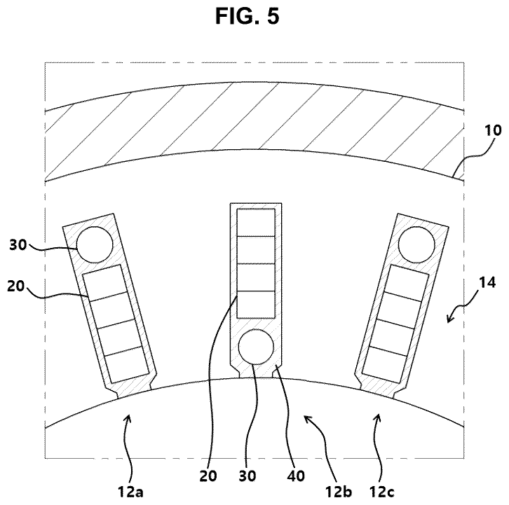

FIG. 5 is a transverse plane of a stator body and slots according to still another embodiment of the present disclosure.

The internal structure of each slot 12 according to an embodiment of the present disclosure is as follows.

A member having a predetermined shape is inserted into the internal accommodation space of the first slot 12a so as to be adjacent to the outer peripheral surface of the stator body 10, and a stator coil 20 is inserted to be adjacent to the inner peripheral surface of the stator body 10.

The stator coil 20 is inserted into the internal accommodation space of the second slot 12b so as to be adjacent to the outer peripheral surface of the stator body 10, and a member having a predetermined shape is inserted to be adjacent to the inner peripheral surface of the stator body 10.

The molding material composition for a stator is loaded in the internal accommodation spaces of the first slot 12a and the second slot 12b and cured. Accordingly, the cooling passage 30 of the first slot 12a may be formed adjacent to the outer peripheral surface of the stator body 10 to extend toward the rotation shaft 16, and the cooling passage 30 of the second slot 12b may be formed adjacent to the inner peripheral surface of the stator body 10 to extend toward the rotation shaft 16.

The third slot 12c may have the same structure as the first slot 12a. Accordingly, slots having the same internal structure as the first slot 12a and slots having the same internal structure as the second slot 12b may be arranged alternately.

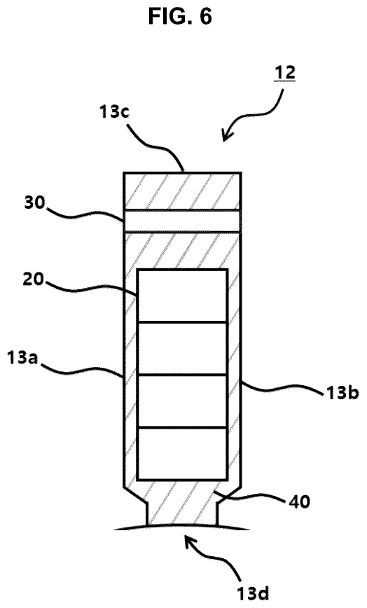

FIG. 6 is a transverse plane showing the arrangement relationship between the cooling passage and the stator coil in the slot according to an embodiment of the present disclosure.

Referring thereto, the cooling passage 30 may be provided in the slot 12 so as to cross the first side wall 13a and the second side wall 13b of the slot 12. Specifically, the cooling passage 30 may be disposed between the rear wall 13c of the slot and the stator coil 20. The diameter or width of the cooling passage 30 may be from 0.1 mm to tens of millimeters, but is not particularly limited thereto. The molding material composition 40 may be one obtained by filling the slot 12 with the molding material composition according to an embodiment of the present disclosure followed by curing. The molding material composition 40 may be disposed to surround the stator coil 20 and the cooling passage 30. At least one cooling passage 30 may be provided along the rotation shaft 16 of the motor 100, but the number thereof may be appropriately determined in consideration of the end use, size, and output of the motor.

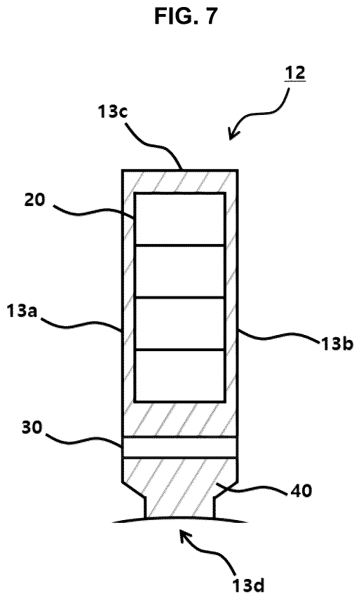

FIG. 7 is a transverse plane showing the arrangement relationship between the cooling passage and the stator coil in the slot according to another embodiment of the present disclosure.

Referring thereto, the cooling passage 30 may be provided in the slot 12 so as to be adjacent to the front wall 13d opposite the rear wall 13c of the slot 12. When the cooling passage 30 is adjacent to the front wall 13d rather than the rear wall 13c of the slot 12, it becomes close to the rotor, and thus heat dissipation performance may be further improved.

### Molding Material Composition for Stator

When the cooling passage 30 according to the present disclosure is formed in the slot 12, particularly when the cooling passage 30 is provided to cross the first side wall 13a and the second side wall 13b, it is difficult to apply a meta-aramid-based insulator for mass production conventionally used for a stator. In the present disclosure, the molding material composition for a stator may be used in lieu of a conventional insulator for mass production. The molding material composition for a stator according to the present disclosure has excellent material flowability, making it easy for bulk molding and large-area molding, and also, heat dissipation performance may be further improved by virtue of gap filling characteristics and high thermal conductivity.

The molding material composition for a stator according to an embodiment of the present disclosure may include a first filler having an average particle diameter (D50) of 10 μm to 25 μm, a second filler having an average particle diameter (D50) of 15 μm to 35 μm and having electrical conductivity, a third filler having an average particle diameter (D50) of 0.3 μm to 5.0 μm and having electrical conductivity, a thermosetting resin, a curing agent, and an additive.

The molding material composition for a stator according to the present disclosure may include a mixture of three types of fillers with different average particle diameters, so that the space between fillers with relatively large particle diameters is filled with fillers with relatively small particle diameters in the composition, thus improving filling properties, thereby increasing thermal conductivity and improving heat dissipation performance.

Specifically, the first filler serves to improve strength and flowability of the molding material composition for a stator, and may include spherical silica having a predetermined average particle diameter (D50). The average particle diameter (D50) may indicate the diameter of particles at which cumulative volume corresponds to 50 vol % in the particle size distribution.

The average particle diameter (D50) of the first filler may be 10 μm to 25 μm, 10 μm to 20 μm, 15 μm to 25 μm, or 15 μm to 20 μm.

The particle cut size of the first filler may be 50 μm to 100 μm, 50 μm to 90 μm, 50 μm to 80 μm, 60 μm to 100 μm, 60 μm to 90 μm, 60 μm to 80 μm, 70 μm to 100 μm, 70 μm to 90 μm, or 70 μm to 80 μm. For the first filler, for example, the residue on sieve of a 75 μm particle cut size may be 0.1 wt % or less.

When the average particle diameter (D50) and the particle cut size of the first filler fall in the above ranges, fine gap filling characteristics may be obtained, whereas when they fall outside the above ranges, fine gaps with a width of 150 μm cannot be filled.

As used herein, the term “particle cut size” may refer to a limit particle size that does not include particles having a size exceeding the corresponding particle size.

In the present disclosure, the molding material composition for a stator may include the first filler in an amount of 1 wt % to 35 wt %, 1 wt % to 30 wt %, 1 wt % to 25 wt %, 1 wt % to 20 wt %, 1 wt % to 15 wt %, or 1 wt % to 10 wt %, based on the total weight of the composition. When the amount of the first filler falls in the above range, the EMC composition may have appropriate strength and flowability.

The second filler serves to improve thermal conductivity of the molding material composition for a stator, and may include at least one selected from among alumina (aluminum oxide, Al₂O₃), boron nitride (BN), aluminum nitride (AlN), silicon nitride (Si₃N₄), magnesia (magnesium oxide, MgO), zinc oxide (ZnO), silicon carbide (SiC), and aluminum hydroxide (Al(OH)₃), as particles having a predetermined average particle diameter (D50).

The average particle diameter (D50) of the second filler may be 15 μm to 35 μm, 15μ m to 30 μm, 15 μm to 25 μm, 20 μm to 35 μm, 20μ m to 30 μm, or 20μ m to 25μ m.

The particle cut size of the second filler may be 50 μm to 100 μm, 50 μm to 90 μm, 50 μm to 80 μm, 60 μm to 100 μm, 60 μm to 90 μm, 60 μm to 80 μm, 70 μm to 100 μm, 70 μm to 90 μm, or from 70 μm to 80 μm. For the second filler, for example, the residue on sieve of a 53 μm particle cut size may be 0.1 wt % or less.

When the average particle diameter (D50) and the particle cut size of the second filler fall in the above ranges, fine gap filling characteristics may be obtained, whereas when they fall outside the above ranges, fine gaps with a width of 150 μm cannot be filled.

In the present disclosure, the molding material composition for a stator may include the second filler in an amount of 15 wt % to 50 wt %, 15 wt % to 45 wt %, 25 wt % to 50 wt %, 25 wt % to 45 wt %, 35 wt % to 50 wt %, or 35 wt % to 45 wt %, based on the total weight of the composition.

When the amount of the second filler falls in the above range, the molding material composition for a stator may have appropriate thermal conductivity, particularly thermal conductivity of 0.85 W/mK to 5.00 W/mK. More particularly, the molding material composition may have thermal conductivity of 3.00 W/mK to 5.00 W/mK.

The third filler serves to improve thermal conductivity of the molding material composition for a stator, and may include at least one selected from among alumina (aluminum oxide, Al₂O₃), boron nitride (BN), aluminum nitride (AlN), silicon nitride (Si₃N₄), magnesia (magnesium oxide, MgO), zinc oxide (ZnO), silicon carbide (SiC), and aluminum hydroxide (Al(OH)₃), as particles having an average particle diameter (D50) different from that of the second filler.

The average particle diameter (D50) of the third filler may be 0.3 μm to 5.0 μm, 0.3 μm to 4.0 μm, 0.3 μm to 3.0 μm, 0.5 μm to 5.0 μm, 0.5 μm to 4.0 μm, 0.5 μm to 3.0 μm, 1.0 μm to 5.0 μm, 1.0 μm to 4.0 μm, 1.0 μm to 3.0 μm, 1.5 μm to 5.0 μm, 1.5 μm to 4.0 μm, 1.5 μm to 3.0 μm, 2.0 μm to 5.0 μm, 2.0 μm to 4.0 μm, or 2.0 μm to 3.0 μm.

The particle cut size of the third filler may be 5 μm to 20 μm or 5 μm to 15 μm. For the third filler, for example, the residue on sieve of a 10 μm particle cut size may be 0.1 wt % or less.

When the average particle diameter (D50) and the particle cut size of the third filler fall in the above ranges, fine gap filling characteristics may be obtained, whereas when they fall outside the above ranges, fine gaps with a width of 150 μm cannot be filled.

In the present disclosure, the molding material composition for a stator may include the third filler in an amount of 15 wt % to 50 wt %, 15 wt % to 45 wt %, 25 wt % to 50 wt %, 25 wt % to 45 wt %, 35 wt % to 50 wt %, or 35 wt % to 45 wt %, based on the total weight of the composition.

When the amount of the third filler falls in the above range, the EMC composition may have appropriate thermal conductivity, particularly thermal conductivity of 0.85 W/mK to 5.00 W/mK, more particularly thermal conductivity of 3.00 W/mK to 5.00 W/mK.

Also, in addition to the first filler, the second filler, and the third filler, an inorganic filler may be further included within a range that does not impair the properties of the present disclosure.

The thermosetting resin is a main resin for curing reaction and may include at least one selected from among an epoxy resin, a phenol resin, and a polyurethane resin. An example of the thermosetting resin may include, but is not limited to, an epoxy resin having both thermosetting and non-conductive properties.

For example, an epoxy resin containing two or more epoxy groups in the molecule may be used, and may include at least one selected from among a bisphenol-type epoxy resin, an alicyclic epoxy resin, a novolac epoxy resin, a dicyclopentadiene-type epoxy resin, a biphenyl-type epoxy resin, a naphthalene-type epoxy resin, an anthracene-type epoxy resin, a non-fused ring polycyclic epoxy resin, and a fluorene-modified epoxy resin.

An epoxy resin having a softening point of 40 to 130° C., an epoxy equivalent weight (EEW) of 100 to 500 g/eq, and a viscosity (at 150° C.) of 0.01 to 50 poise may be used, and the epoxy resin that satisfies the properties described above has low melt kneading properties and low viscosity and thus excellent moldability and flowability, so appearance defects such as bubbles, flash, etc. may be suppressed.

In the present disclosure, the molding material composition for a stator may include the thermosetting resin in an amount of 1 wt % to 15 wt %, 1 wt % to 13 wt %, 1 wt % to 10 wt %, 5 wt % to 15 wt, 5 wt % to 13 wt %, or 5 wt % to 10 wt %, based on the total weight of the composition.

The curing agent serves to proceed with curing reaction by reacting with the epoxy resin, and any curing agent may be used without particular limitation so long as it reacts with the epoxy resin to cause curing reaction. For example, the curing agent may be a phenolic compound having a phenolic hydroxyl group in the molecule, and may include at least one selected from among a phenol novolac resin, a cresol novolac resin, a phenol aralkyl resin, and a polyfunctional phenol compound.

A curing agent having a softening point of 50 to 110° C. and a viscosity (at 150° C.) of 0.01 to 10 poise may be used, and the curing agent that satisfies the properties described above may improve product reliability and strength by suppressing moisture absorption.

In the present disclosure, the molding material composition for a stator may include the curing agent in an amount of 1 wt % to 8 wt %, 1 wt % to 7 wt %, 1 wt % to 6 wt %, 3 wt % to 8 wt %, 3 wt % to 7 wt %, or 3 wt % to 6 wt %, based on the total weight of the composition.

The additive may include silane, wax, a colorant, a catalyst, and a flame retardant, but the present disclosure is not limited thereto.

Since silane has both a reactive group able to bind to an organic functional group and a reactive group able to bind to an inorganic material in the molecule, adhesion between different materials may be increased and properties such as mechanical strength, water resistance, weather resistance, heat resistance, etc. may be improved. In order to prevent deterioration of the properties, silane may include at least one selected from among silane, trimethoxy (3-oxiranylmethoxy) propyl, and 3-aminopropyltriethoxysilane, but the present disclosure is not limited thereto.

The colorant serves to impart color to the molding material composition for a stator, and an example thereof may include, but is not limited to, carbon black having DBP oil absorption, which is a property indicating a specific surface area and a structural state, of 100 cm³/100 g to 150 cm³/100 g, and a residue on sieve of a 45 μm particle cut size of 100 ppm or less.

The catalyst may contribute to adjusting a curing rate and workability, and an imidazole-based compound may be used. Examples of the imidazole-based compound may include, but are not limited to, 2-methylimidazole, 2-phenylimidazole, 2-aminoimidazole, 2-methyl-1-vinylimidazole, 2-ethyl-4-methylimidazole, 2-heptadecylimidazole, and the like.

The flame retardant may contribute to flame retardancy of the molding material composition for a stator, and examples thereof may include, but are not necessarily limited to, metal hydroxides, and phosphorus- and nitrogen-containing organic compounds (e.g., resorcinol diphosphate, phosphate, phenoxy phosphazene, melamine cyanurate, and phenol melamine resin), which may be used alone or in combination of two or more. Also, the additive may further include ion trappers (e.g., hydrotalcite type), long-chain fatty acids, metal salts of long-chain fatty acids, release agents such as paraffin wax, carnauba wax, and polyethylene wax, modifiers, modified silicone resins, etc. The additive may be included to improve function within a range that does not impair the properties of the present disclosure.

In the present disclosure, the molding material composition for a stator may include the additive in an amount of 2 wt % to 25 wt %, 5 wt % to 25 wt %, or 7 wt % to 25 wt %, based on the total weight of the composition.

The molding material composition for a stator according to an embodiment of the present disclosure may have thermal conductivity of 0.85 W/mK to 5.00 W/mK, 1.00 W/mK to 5.00 W/mK, 1.50 W/mK to 5.00 W/mK, 2.00 W/mK to 5.00 W/mK, 2.50 W/mK to 5.00 W/mK, 3.00 W/mK to 5.00 W/mK, or 3.50 W/mK to 5.00 W/mK, as measured according to ASTM E1461.

The molding material composition for a stator according to an embodiment of the present disclosure is capable of gap filling for a gap having a width of 100 mm, a length of 10 mm, and a thickness of 150 μm under molding conditions according to ASTM D 3123-72, and for each gap having the same width and length dimensions as the molding above, but having a thickness of 200 μm, 250 μm, or 300 μm.

A better understanding of the molding material composition for a stator according to an embodiment of the present disclosure may be obtained through the following preparation examples and test examples. These preparation examples and test examples are merely set forth to illustrate the present disclosure and are not to be construed as limiting the scope of the present disclosure.

### 1. PREPARATION EXAMPLES

### 1-1. Preparation of Examples

The components shown in Table 1 below were prepared and mixed in the amounts according to Table 2 below. The mixture was melt-mixed at a temperature of 80° C. to 120° C. using a dispersion machine, followed by cooling to room temperature and grinding to prepare molding material compositions for stators of Examples 1 to 4 of the present disclosure.

TABLE 1

| Classification | Component (chemical formula/IUPAC) |
|---|---|
| Epoxy resin | Formaldehyde polymer with (chloromethyl)oxirane |
| | and 2-methylphenol Cas. No.: 0029690-82-2 |
| | Epoxy equivalent weight: 201 g/eq |
| Curing agent | Phenol polymer with formaldehyde |
| | Cas No.: 0009003-35-4 |
| | Equivalent weight: 106 g/eq |
| Filler | Silica (silicon dioxide (surface treated)) |
| | Average particle diameter: 18 μm 5 wt % |
| | Alumina |
| | Average particle diameter: 23.5 μm (50%) |
| | Average particle diameter: 2.2 μm (50%) |
| Silane | Silane, trimethoxy[3-(oxiranylmethoxy)propyl] |
| Wax | Polyethylene wax/Carnauba wax |
| Colorant | Carbon black Specific surface area: |
| | 140 m²/g, DBP absorption: 115-131, pH: 7 |
| Catalyst | Imidazole catalyst: 2-methylimidazole |
| Flame retardant | Aluminum hydroxide (Al(OH)₃) |
| | Magnesium hydroxide (Mg(OH)₂ |

The average particle diameter may indicate the particle diameter at which the volume accumulation is 50% in the volume curve of the particle size distribution measured by laser diffraction, and may also be called the median diameter. Specifically, the particle size distribution may be determined on a volume basis by a laser diffraction method, and the particle diameter at the point where the cumulative value is 50% in the cumulative curve with the total volume set to 100% may be determined as the average particle diameter, and this average particle diameter may be, as another example, called the median particle diameter or D50 particle diameter.

TABLE 2

| Classification (wt %) | Example 1 | Example 2 | Example 3 | Example 4 |
|---|---|---|---|---|
| Epoxy resin | 7.8 | 7.8 | 7.8 | 7.8 |
| Curing agent | 4.5 | 4.5 | 4.5 | 4.5 |
| First filler (silica) | 35 | 25 | 15 | 5 |
| Second filler (alumina-A) | 25 | 30 | 35 | 40 |
| Third filler (alumina-B) | 25 | 30 | 35 | 40 |
| Silane | 0.4 | 0.4 | 0.4 | 0.4 |
| Wax | 0.7 | 0.7 | 0.7 | 0.7 |
| Colorant | 0.2 | 0.2 | 0.2 | 0.2 |
| Catalyst | 0.2 | 0.2 | 0.2 | 0.2 |
| Flame retardant | 1.2 | 1.2 | 1.2 | 1.2 |
| Total | 100 | 100 | 100 | 100 |

* The average particle diameter (D 50) and particle cut size of silica, alumina-A, and alumina-B components are as follows:
Silica: Product with average particle diameter of 18 μm and particle cut size of 75 μm
Alumina-A: Product with average particle diameter of 23.5 μm and particle cut size of 75 μm
Alumina-B: Product with average particle diameter of 2.2 μm (50%) and particle cut size of 10 μm

### 1-2. Preparation of Comparative Examples

The EMC compositions of Comparative Examples 1 to 4 were prepared by mixing components in the amounts according to Table 3 below.

TABLE 3

| | Comparative | Comparative | Comparative | Comparative |
|---|---|---|---|---|
| Items (wt %) | Example 1 | Example 2 | Example 3 | Example 4 |
| Epoxy resin | 7.8 | 7.8 | 7.8 | 7.8 |
| Curing agent | 4.5 | 4.5 | 4.5 | 4.5 |
| Silica | 85 | 15 | 15 | 15 |
| Alumina-A | — | — | — | — |
| Alumina-B | — | 35 | 35 | 35 |
| Alumina-C | — | 35 | — | — |
| Alumina-D | — | — | 35 | — |
| Alumina-E | — | — | — | 35 |
| Silane | 0.4 | 0.4 | 0.4 | 0.4 |
| Wax | 0.7 | 0.7 | 0.7 | 0.7 |
| Colorant | 0.2 | 0.2 | 0.2 | 0.2 |
| Catalyst | 0.2 | 0.2 | 0.2 | 0.2 |
| Flame retardant | 1.2 | 1.2 | 1.2 | 1.2 |
| Total | 100 | 100 | 100 | 100 |

* The average particle diameter (D 50) and particle cut size of alumina-C, alumina-D, and alumina-E components are as follows:
Alumina-C: Product with average particle diameter of 35 μm and particle cut size of 105 μm
Alumina-D: Product with average particle diameter of 48 μm and particle cut size of 150 μm
Alumina-E: Product with average particle diameter of 55 μm and particle cut size of 180 μm

### 2. TEST EXAMPLES

### 2-1. Evaluation Methods

As a total of four evaluation items, S/F (spiral flow), G/T (gel time), thermal conductivity, and fine gap filling characteristics of the molding material composition for a stator were evaluated. Specific evaluation methods are as follows.
S/F (spiral flow): The temperature of a mold press is set to 175° C., and the actual mold temperature is tested at 170±5° C. The transfer pressure is set at 1,000±25 psi, and the transfer speed is set at 1 to 4 inches/sec. The curing time is set to 120 sec. Spiral flow is measured using a spiral flow measurement mold specified in ASTM D 3123-72. Thereafter, an appropriate amount of the sample is taken so that the cull thickness is 3±0.5 mm, and then spiral flow is measured.
G/T (gel time): A hot plate is preheated based on an actual temperature of 170° C.±3° C. 2 g of a sample is placed on the hot plate and a stopwatch starts. After forming a thin film using a spatula, the stopwatch is stopped and the time is read at the end point at which the film begins to break down as curing begins.
Thermal conductivity: A circular specimen with a diameter of 30 mm×a thickness of 2 mm is manufactured, and thermal conductivity thereof is measured using a thermal conductivity meter. The specimen molding conditions are the same as the S/F measurement conditions.
Fine gap filling: To evaluate fine gap filling, the following mold is manufactured. The top plate of a mold is manufactured in a horizontal state, and the bottom plate of the mold is manufactured by engraving in the following size (mold size: width 100 mm×length 10 mm×thickness (150 μm/200 μm/250 μm/300 μm)×air vent 10 μm). After molding the molding material composition for a stator in the corresponding mold using a transfer molding machine, whether the molding material composition has been molded at each thickness portion is determined. Here, if the molding material composition is completely molded without leaving any part of the mold, it is judged as OK, and if not, it is judged as NG. The molding conditions are the same as S/F measurement conditions.

### 2-2. Evaluation Results

The evaluation results of the compositions of Examples 1 to 4 and Comparative Examples 1 to 4 are shown in Table 4 below.

TABLE 4

| Classification | | | | | | | | | |
|---|---|---|---|---|---|---|---|---|---|
| (unit) | | Ex. 1 | Ex. 2 | Ex. 3 | Ex. 4 | C. Ex. 1 | C. Ex. 2 | C. Ex. 3 | C. Ex. 4 |
| S/F (spiral flow) | | 45 | 44 | 43 | 42 | 46 | 44 | 44 | 43 |
| (inch) | | | | | | | | | |
| G/T (gel time) | | 33 | 34 | 33 | 33 | 33 | 34 | 33 | 33 |
| (sec) | | | | | | | | | |
| Thermal | | 0.95 | 1.51 | 3.05 | 3.61 | 0.83 | 3.04 | 3.03 | 3.04 |
| conductivity | | | | | | | | | |
| (W/mK) | | | | | | | | | |
| Fine | 150 μm | OK | OK | OK | OK | OK | NG | NG | NG |
| gap | 200 μm | OK | OK | OK | OK | OK | NG | NG | NG |
| filling | 250 μm | OK | OK | OK | OK | OK | OK | NG | NG |
| | 300 μm | OK | OK | OK | OK | OK | OK | OK | NG |

Referring to Table 4, Examples 1 to 4 were judged OK in all when evaluating fine gap filling, but Comparative Examples 2 to 4 were judged NG in some or all and did not satisfy the gap filling characteristics. In Comparative Examples 2 to 4 including alumina with a particle cut size (max size) of 105 μm or more, a thickness of 200 μm or less was not molded.

Comparative Example 1 satisfied gap filling characteristics, but due to the use of silica, thermal conductivity was about 0.83 W/mK, which did not reach the target value of 3 W/mK. Only in Examples 3 and 4 and Comparative Examples 2 to 4, in which the amount of the filler was 85 wt % and the total amount of alumina was 70 wt % or more, was thermal conductivity measured to be 3.0 W/mK or more.

For the molding material composition for a stator capable of replacing a stator insulator, the thickness of the molding material composition molded inside the slots is very low, at the level of 180 to 220 μm. Accordingly, the cut size (max size) of the fillers (silica and alumina) used has to be managed to less than 75 μm. The molding material composition for a stator according to an embodiment of the present disclosure is capable of obtaining fine gap filling characteristics and achieving thermal conductivity of 3.0 W/mK or more, making it possible to apply the molding material composition to molding, thereby increasing heat dissipation performance when applied to molding.

As is apparent from the above description, a molding material composition for a stator according to the present disclosure has material flowability (bulk molding) and gap filling characteristics (180 μm), enabling precision molding (48 slots/thickness of 180-220 μm) for a stator with a large capacity (outer diameter of 200 mm/length of 160 mm).

The molding material composition for a stator can be used to replace existing meta-aramid insulators, and the cooling system with the molding material composition applied to the stator has increased heat dissipation performance due to high thermal conductivity of the molding material composition. In particular, the cooling system can further maximize the heat dissipation effect by providing cooling passages in the slots.

The effects of the present disclosure are not limited to the foregoing. It should be understood that the effects of the present disclosure include all effects that can be inferred from the description of the present disclosure.

1. A molding material composition for a stator, comprising:
a first filler having an average particle diameter (D50) of 10 μm to 25 μm;
a second filler having an average particle diameter (D50) of 15 μm to 35 μm and having electrical conductivity;
a third filler having an average particle diameter (D50) of 0.3 μm to 5.0 μm and having electrical conductivity;
a thermosetting resin;
a curing agent; and
an additive.

2. The molding material composition of claim 1, wherein:
the first filler comprises silica (silicon dioxide, SiO₂);
the second filler comprises at least one selected from among alumina (aluminum oxide, Al₂O₃), boron nitride (BN), aluminum nitride (AlN), silicon nitride (Si₃N₄), magnesia (magnesium oxide, MgO), zinc oxide (ZnO), silicon carbide (SiC), and aluminum hydroxide (Al(OH)₃); and
the third filler comprises at least one selected from among alumina (aluminum oxide, Al₂O₃), boron nitride (BN), aluminum nitride (AlN), silicon nitride (Si₃N₄), magnesia (magnesium oxide, MgO), zinc oxide (ZnO), silicon carbide (SiC), and aluminum hydroxide (Al(OH)₃).

3. The molding material composition of claim 1, wherein:
the thermosetting resin comprises at least one selected from among an epoxy resin, a phenol resin, and a polyurethane resin; and
the curing agent comprises at least one selected from among a phenol novolac resin, a cresol novolac resin, a phenol aralkyl resin, and a polyfunctional phenol compound.

4. The molding material composition of claim 1, wherein the composition comprises, based on a total weight of the composition:
1 wt % to 35 wt % of the first filler;
15 wt % to 50 wt % of the second filler; and
15 wt % to 50 wt % of the third filler.

5. The molding material composition of claim 1, wherein the composition comprises, based on a total weight of the composition:
1 wt % to 35 wt % of the first filler;
15 wt % to 50 wt % of the second filler;
15 wt % to 50 wt % of the third filler;
1 wt % to 15 wt % of the thermosetting resin;
1 wt % to 8 wt % of the curing agent; and
2 wt % to 25 wt % of the additive.

6. The molding material composition of claim 1, wherein the composition has a thermal conductivity of 0.85 W/mK to 5.00 W/mK as measured according to ASTM E1461.

7. The molding material composition of claim 1, wherein the composition is capable of gap filling for a gap having a width of 100 mm, a length of 10 mm, and a thickness of 150 μm to 300 μm under molding conditions according to ASTM D 3123-72.

8. A cooling system, comprising:
a stator body comprising a plurality of teeth and a plurality of slots;
a stator coil inserted into each of the plurality of slots; and
a molding material composition for a stator loaded inside of each of the plurality of slots and configured to cover the stator coil;
wherein the molding material composition comprises a first filler having an average particle diameter (D50) of 10 μm to 25 μm and a particle size (D10) of 50 μm to 100 μm, a second filler having an average particle diameter (D50) of 15 μm to 35 μm and a particle size (D10) of 50 μm to 100 μm and having electrical conductivity, a third filler having an average particle diameter (D50) of 0.5 μm to 5 μm and a particle size (D10) of 5 μm to 20 μm and having electrical conductivity, a thermosetting resin, a curing agent, and an additive.

9. The cooling system of claim 8, wherein:
each of the plurality of slots comprises at least one cooling passage therein;
the at least one cooling passage has a hollow tube shape to allow a cooling medium to flow; and
the at least one cooling passage is provided in each slot so as to cross a first side wall and a second side wall of the slot.

10. The cooling system of claim 8, wherein a cooling passage is disposed between a rear wall of each slot and the stator coil.

11. The cooling system of claim 8, wherein a cooling passage is disposed adjacent to a front wall opposite a rear wall of each slot.

12. The cooling system of claim 8, wherein at least one cooling passage is provided to cross a first side wall and a second side wall of each slot, and a second cooling passage is disposed adjacent to a front wall opposite a rear wall of the slot.

13. The cooling system of claim 8, wherein:
the first filler comprises silica (silicon dioxide, SiO₂);
the second filler comprises at least one selected from among alumina (aluminum oxide, Al₂O₃), boron nitride (BN), aluminum nitride (AlN), silicon nitride (Si₃N₄), magnesia (magnesium oxide, MgO), zinc oxide (ZnO), silicon carbide (SiC), and aluminum hydroxide (Al(OH)₃); and
the third filler comprises at least one selected from among alumina (aluminum oxide, Al₂O₃), boron nitride (BN), aluminum nitride (AlN), silicon nitride (Si₃N₄), magnesia (magnesium oxide, MgO), zinc oxide (ZnO), silicon carbide (SiC), and aluminum hydroxide (Al(OH)₃).

14. The cooling system of claim 8, wherein:
the thermosetting resin comprises at least one selected from among an epoxy resin, a phenol resin, and a polyurethane resin; and
the curing agent comprises at least one selected from among a phenol novolac resin, a cresol novolac resin, a phenol aralkyl resin, and a polyfunctional phenol compound.

15. The cooling system of claim 8, wherein the molding material composition comprises, based on a total weight of the composition:
1 wt % to 35 wt % of the first filler;
15 wt % to 50 wt % of the second filler; and
15 wt % to 50 wt % of the third filler.

16. The cooling system of claim 8, wherein the composition comprises, based on a total weight of the composition:
1 wt % to 35 wt % of the first filler;
15 wt % to 50 wt % of the second filler;
15 wt % to 50 wt % of the third filler;
1 wt % to 15 wt % of the thermosetting resin;
1 wt % to 8 wt % of the curing agent; and
2 wt % to 25 wt % of the additive.

17. The cooling system of claim 8, wherein the molding material composition has a thermal conductivity of 0.85 W/mK to 5.00 W/mK as measured according to ASTM E1461.

18. The cooling system of claim 8, wherein the molding material composition is capable of gap filling for a gap having a width of 100 mm, a length of 10 mm, and a thickness of 150 μm to 300 μm under molding conditions according to ASTM D 3123-72.
